(19) United States
(12) Patent Application Publication
(10) Pub. No.: US 2009/0199882 A1
(43) Pub. Date: Aug. 13, 2009

(54) Method and device for cleaning welding torches

(75) Inventors: Harald Langeder, Pettenbach (AT); Helmut Friedl, Sipbachzell (AT); Erich Egelseder, Kirchdorf/Krems (AT); Georg Binder, Pettenbach (AT)

Correspondence Address: COLLARD & ROE, P.C., 1077 NORTHERN BOULEVARD, ROSLYN, NY, 11576, US

(73) Assignee: Fronius International GmbH

(21) Appl. No.: 12/384,884

(22) Filed: Apr. 9, 2009

Related U.S. Application Data
(62) Division of application No. 10/530,838, filed on Apr. 8, 2005.

(30) Foreign Application Priority Data
Oct. 31, 2002 (DE) 202 16 788.7

(51) Int. Cl. B23K 9/32; B08B 3/04

(52) U.S. Cl. 134/57 R; 134/104.4; 134/198; 134/184; 134/113; 134/115 R

(57) ABSTRACT

A device for cleaning welding torches includes a device for applying cleaning or wetting liquid to the tip of the welding torch and a coil with an opening for inserting the welding torch in order to subject it to an electromagnetic cleaning. The device also includes an electric power supply device that is connected to the coil. The device for applying cleaning liquid, which consists of, for example, a reservoir or nozzles, and the coil are placed inside a common housing together with a refuse reservoir, which is located underneath the coil while serving to hold the electromagnetically removed foreign substances. Preferably, the device for applying cleaning liquid is placed inside or underneath the opening of the coil thereby enabling the welding torch to be located in essentially the same position during cleaning.

### CROSS REFERENCE TO RELATED APPLICATIONS

This application is a divisional of and Applicants claim priority under 35 U.S.C. §§ 120 and 121 of parent U.S. patent application Ser. No. 10/530,838 filed Apr. 8, 2005. Applicants claim priority under 35 U.S.C. §119 of German Application No. 202 16 788.7 filed Oct. 31, 2002. Applicants also claim priority under 35 U.S.C. §365 of PCT/AT2003/000326 filed Oct. 31, 2003. The international application under PCT article 21(2) was not published in English.

The invention relates to a method for cleaning welding torches, wherein a cleaning or wetting liquid is applied to the tip of the welding torch and the tip of the welding torch is subsequently exposed to an electromagnetic field for the contactless removal of foreign substances.

Furthermore, the invention relates to an apparatus for cleaning welding torches, including a device for applying cleaning liquid to the tip of the welding torch, and a coil having an opening for the insertion of the welding torch to subject the same to electromagnetic cleaning, and an electric power supply device connected with said coil.

During welding procedures, welding torches are dirtied by molten metal spatters. Metal spatters also deposit within the gas nozzle of the welding torch and solidify there. The protection gas flow through the gas nozzle is consequently disturbed by the deposited metal spatters such that even atmospheric air may reach the welding site and hence negatively influence the welding process. A perfectly operating and largely clean welding torch is, therefore, important for the production of a high-quality weld.

As a result, welding torches are regularly cleaned from adhering metal spatters. During cleaning, the welding torch is not available for welding operations. It is therefore, endeavoured to perform such cleaning as rapidly as possible. There are mechanical methods for cleaning welding torches, in which deposits are removed from the tip of the welding torch by the aid of brushes, knives or the like. However, such mechanical cleaning methods render feasible only to a limited extent the perfect cleaning of the interior of the gas nozzle of a welding torch. Components of the welding torch are, moreover, damaged by mechanical actions such that their service lives will be reduced. Damage to the surfaces of a welding torch component will even promote the adherence of weld spatters to the same, which will result in a more rapid obstruction of the gas nozzle and call for frequent cleaning of the welding torch. The welding torch should moreover be cooled prior to cleaning, which would again extend the cleaning time.

U.S. Pat. No. 4,838,287 A describes a method for cleaning welding torches, which allows for the contactless cleaning of a welding torch by using a coil through which electric current flows. To this end, the tip of the welding torch is introduced into the opening of the coil and a suitable current pulse is applied. The resulting electromagnetic field generates appropriate magnetic forces also acting on the deposits on the welding torch and thereby removing the same. During the removal of the deposits, no mechanical action is exerted on parts of the welding torch so as to spare them and increase their service lives.

In order to cool the welding torch prior to electromagnetic cleaning on the one hand, and facilitate the removal of foreign substances by appropriate cleaning agents on the other hand, the welding torch is usually immersed into a liquid. That liquid may be comprised of water or mixtures of water with special solvents. For an efficient electromagnetic cleaning, it will be advantageous if the metal spatters on the welding torch are rapidly cooled by immersion into a cleaning liquid. Due to the different thermal expansions of the metal spatters and the gas nozzle, which is usually made of copper, such rapid cooling causes a reduced adherence of the metal spatters to the welding torch.

An arrangement for cleaning welding torches comprising a liquid-filled tub for immersing the welding torch and a coil for the electromagnetic cleaning of the welding torch is, for instance, described in WO 01/56730 A2. There, a post containing the liquid tub and the coil is arranged directly beside the workpiece to be welded such that the welding torch, which, in particular, is mounted to a robot arm, may be automatically cleaned even between the welding procedures. It is, however, disadvantageous that, for instance, no place is available on the post for coil supply devices, the latter having to be connected via appropriate wires. Such wires provided between the supply device and the cleaning unit may transmit electromagnetic fields derived from the high current pulses, which may lead to failures of other appliances or control systems.

Finally, it is also feasible to clean welding torches by the aid of jet nozzles, via which cold medium is directed onto the surface to be cleaned by means of a compressed-air flow. A method and apparatus of this type for cleaning welding torches are, for instance, known from DE 100 63 572 A1.

It is the object of the present invention to provide a cleaning method and a cleaning apparatus of the defined kind, which promote rapid and automatizable cleaning and are especially suitable for welding robot applications. In addition, the device is to be structured as simply and cost-effectively as possible and mountable and dismountable as rapidly and simply as possible. The disposal of the foreign substances removed during cleaning is to be as easy as possible.

The object of the invention in method terms is achieved in that the welding torch is substantially in the same position during the application of the cleaning liquid or wetting liquid and the subsequent exposure to an electromagnetic field. The step of moving the welding torch from the container with the cleaning liquid to the coil for electromagnetic spatter removal during welding-torch cleaning may, therefore, be obviated, which will result in a substantial reduction of the cleaning time involved. That the welding torch is substantially in the same position during the cleaning procedure is meant to imply that slight changes in position, for instance in the longitudinal direction of the welding torch, are permissible. Such slight changes in position, however, involve only little time, which is why the cleaning method can nevertheless be carried out very rapidly. By contrast, the welding torch in conventional cleaning methods must be newly positioned from the container with the cleaning liquid to the coil during the cleaning procedure, which change in position will optionally have to be repeated several times. Those operating steps require additional time and, thus, increase the overall cleaning time of the welding torch, during which the latter will not be available for welding processes. In those methods, the position must be defined twice when taking the welding robot into operation.

The application of cleaning liquid to the tip of the welding torch may be realized by immersing the welding torch into the cleaning liquid. In doing so, the welding torch may be moved within a tub containing the cleaning liquid, or the tub may be moved to the welding torch with the welding torch keeping its position.

It is likewise feasible to apply cleaning liquid by spraying the tip of the welding torch with cleaning liquid. Spraying offers the advantage of consuming less cleaning liquid, on the one hand, and enabling the directed application of the cleaning liquid also in the interior of the welding torch, on the other hand. Furthermore, spraying cleaning liquid onto the tip of the welding torch offers the advantage over immersion into a container with cleaning liquid that no resistance will be exerted by the liquid against the separation of metal spatters.

The cleaning liquid or wetting liquid cools the welding torch and also facilitates the subsequent electromagnetic removal of foreign substances.

At an elevated degree of dirt accumulation on the welding torch, the steps of applying cleaning liquid and electromagnetically removing foreign substances may be repeated. In the method according to the invention the position of the welding torch need not at all, or not substantially, be changed, thus allowing the cleaning process to be rapidly performed even with several scatter removals, and hence maximizing the service life of the welding torch.

With the appropriate arrangement below the coil for electromagnetic cleaning, of the device for applying cleaning liquid, the welding torch, according to a further characteristic feature of the invention, for applying said cleaning liquid may be lowered relative to the position assumed during electromagnetic spatter removal.

The object according to the invention is also achieved by an above-described apparatus for purifying welding torches, wherein the device for applying cleaning liquid and the coil are arranged in a common housing together with a waste receptacle arranged below the coil to receive the electromagnetically removed foreign substances. Hence results a particularly compact unit that can be taken very rapidly to the respective place of use, where it can be set working after only a few operating steps. By such integration of the waste receptacle, surrounding areas will not be affected by removed metal spatters or the like. The waste receptacle may be readily freed of the foreign substances contained therein at regular intervals.

The device for applying cleaning liquid may be comprised of a tub containing cleaning liquid for the immersion of the welding torch, into which the welding torch is immersed prior to electromagnetic spatter removal.

The device for applying cleaning liquid may likewise be comprised of at least one nozzle. By the aid of said at least one nozzle, the cleaning liquid may be selectively directed to those regions of the welding torch which are dirtied the most. It is, for instance, also feasible to inject the cleaning liquid by the aid of a nozzle into the interior of the welding torch, or the gas nozzle of the welding torch, where welding spatters would frequently collect too.

In an advantageous manner, the supply device for the coil is also arranged within said housing. The common housing, thus, need only be connected to the supply voltage in order to supply the coil with appropriate electric power. This arrangement does not require any extended connection cables between the supply unit and the coil, which might lead to failures of other appliances and control systems on account of the high current pulses.

If the waste receptacle is pivotally arranged, it may be pivoted out of the region below the coil in the case of non-use. In this manner, space may, for instance, be provided for the tub containing the cleaning liquid, or for the nozzles applying the cleaning liquid. After the application of the cleaning liquid, the waste receptacle may again be pivoted into the region below the opening of the coil so as to enable the collection of the foreign substances dropping down during electromagnetic spatter removal. The waste receptacle may also be used to receive dropping-down or flowing-down cleaning liquid. In this case, the waste receptacle is preferably located below the opening of the coil during the whole cleaning procedure. The waste receptacle may be equipped with a solids separator.

In order to facilitate emptying of the waste receptacle, it is provided that the latter is removable from the housing. This may, for instance, be realized by a construction in the form of a drawer or the like.

In order to enable the device for applying cleaning liquid to be supplied with cleaning liquid, if required, a refill container connected with the device for applying cleaning liquid is arranged within the housing according to a further characteristic feature of the invention. In this case, the supply of the device for applying cleaning liquid with a sufficient amount of liquid preferably occurs automatically. This may, for instance, be accomplished by the appropriate arrangement of the refill container in an opposed relationship to the device for applying cleaning liquid, or even by the provision of suitable sensors and pumps.

A liquid connection connected with the device for applying cleaning liquid may likewise be provided, via which the device for applying cleaning liquid can be emptied or supplied with cleaning liquid.

In order to enable the cleaning apparatus to be readily transported to the place of use, and displaced in its position, the housing comprises wheels or the like as in accordance with a further characteristic feature of the invention. In order to enable the cleaning apparatus to be stabilized on the place of use, and fixed in its position, said wheels or the like are provided with appropriate fixing means, or are, for instance, designed to be retractable or foldable.

In order to enable cleaning of the welding torch in a manner as automated as possible, a device for detecting the immersion depth of the welding torch in the coil may be arranged on the opening of the coil. This enables the respectively optimum immersion depth to be reached during a cleaning procedure.

The device for detecting the immersion depth may, for instance, be comprised of a light source or an optical sensor detecting the light rays reflected by a reflex element, preferably a reflex ring, appropriately arranged on the welding torch. It is feasible in this manner to insert the welding torch into the coil until the respective optical sensor receives a signal, whereupon the advance movement of the welding torch into the opening of the coil is stopped. To this end, just one reflex element or reflex ring need be arranged on the welding torch itself. Similarly, the penetration depth of the welding torch in the coil may be indicated by mechanical means such as, for instance, a ring provided on the welding torch and actuating a switch provided on the coil, or by any other construction.

In order to create optimum conditions in respect to the optionally present welding wire in addition to the cleaning of the welding torch, it is provided that a device for cutting a welding wire fed to the welding torch is also arranged in the common housing. By this device, which is also arranged in the cleaning apparatus, the optimum adjustment of the welding wire is likewise feasible after the electromagnetic cleaning of the welding torch. For the optimum functioning of the welding torch, the welding wire is required to project out of the welding torch by a defined length (the so-called stick-out length).

The cutting device in this case is preferably arranged below the coil. This enables the welding wire to be appropriately deflected prior to, during or after electromagnetic cleaning. It is, thus, not required to convey the welding torch to a separate station for cutting off the welding wire. The time involved in the cleaning of the welding torch may, thus, be kept low, so that the welding torch will be quickly available again for welding operations.

According to a further characteristic feature of the invention, it is provided that a stop plate is arranged below the coil, against which the welding wire is advanced in order to adjust the length by which the welding wire projects out of the welding torch. The above mentioned stick-out length can, thus, be set to the optimum value.

The stop plate may be made of an electrically conductive material such that the impact of the welding wire is detectable by the resulting electrical contact. Such constructions may also be replaced with optical sensors for detecting the stick-out length.

In order to obtain the optimum temperature of the cleaning liquid, a device for controlling the temperature of the cleaning liquid is preferably provided. This may be comprised of a closed loop which keeps the cleaning liquid constantly at a defined temperature, or of an externally influenceable control loop, wherein it is feasible to set different temperature levels, for instance, in order to create respectively optimum conditions for different welding torches.

Suitable sensors may be provided for detecting the presence of a welding torch in the cleaning apparatus. These may comprise optical, inductive, capacitive or even mechanical sensors.

In order to ensure a cleaning procedure as automatizable as possible, suitable sensors may also be provided for detecting the filling level in the tub and/or refill container. Thus, falling short of the liquid level in the tub may cause automatic refilling, or falling short of a given value in the refill container may, for instance, cause the automatic notification of the personnel of a desired exchange of the refill container.

In this case, a control device for controlling the cleaning procedure is advantageously arranged in the housing. Such a control device, which may, for instance, be comprised of a computer or a microprocessor, will automatically perform the whole cleaning procedure.

Instead of a control device arranged in the housing, it is also feasible to provide an interface for connection to a control device for controlling the cleaning procedure on the housing. This allows computers provided, for instance, for the control of the welding robot to be likewise employed for controlling the cleaning procedure.

Said control device or interface for the control device, respectively, is connected with the coil of the coil supply device and the optional device for detecting the immersion depth of the welding torch and the optional cutting device and the optional temperature control device and optional sensors. In this manner, the optimum automatic control of the cleaning procedure is rendered feasible. To this end, all of the existing components in the housing may be interconnected via a bus system.

It is, moreover, suitable if at least one display is arranged on the housing to inform the personnel on operating states. Said display may simply comprise lamps or a screen.

A free space which may preferably serve to accommodate refill containers may be provided below or within the housing. The refill containers may just be stored in the free space, or may be connected via a pump with the liquid tub or nozzles so as to ensure the supply of cleaning liquid to the device for applying cleaning liquid over particularly long periods of time. Hence result extremely long service lives of the cleaning apparatus, which is of particular relevance to automated welding plants as are, for instance, employed in the motorcar industry.

The object according to the invention is also achieved by an above-mentioned cleaning apparatus, wherein the device for applying cleaning liquid is arranged within or below the opening of the coil so as to enable the application of cleaning liquid and said electromagnetic cleaning substantially in the same position of the welding torch. It is, thus, not necessary to reposition the welding torch after the application of the cleaning liquid, which saves time and reduces the cleaning time of the welding torch during which the latter will not be available to welding processes.

The device for applying cleaning liquid may be comprised of a tub containing said cleaning liquid, into which the welding torch is immersed prior to electromagnetic spatter removal. In doing so, the welding torch may be moved in the direction of the tub, as already pointed out above.

Alternatively, also the tub may be connected with a device for, preferably vertical, movement, thus being moved in the direction of the welding torch for the purpose of applying cleaning liquid. Besides being vertically movable, the tub may, for instance, also be pivotally arranged below the opening of the coil and again moved away from this position after the immersion of the welding torch.

The device for applying cleaning liquid may likewise be comprised of at least one nozzle. By the aid of said at least one nozzle, the cleaning liquid may be selectively directed to those regions of the welding torch which are dirtied the most. It is, for instance, also feasible by the aid of a nozzle to inject cleaning liquid into the interior of the welding torch, or the gas nozzle of the welding torch, where welding spatters would frequently collect too.

In this case, several nozzles may be arranged, for instance in an annular manner, within the opening of the coil and be directed towards the welding torch at different angles.

In order to enable also the interior of the welding torch to be selectively provided with cleaning liquid, at least one nozzle is arranged below the opening of the coil and directed towards the tip of the welding torch.

According to a further characteristic feature of the invention, it is provided that at least one nozzle is movably arranged. Such movability allows for the influencing of the direction of the cleaning liquid jet, on the one hand, and also the moving away of the entire nozzle, or all nozzles, during the electromagnetic spatter removal, on the other hand.

In order to enable the device for applying cleaning liquid to be supplied with cleaning liquid, if necessary, a refill container connected with the device for applying cleaning liquid, preferably via a pump or the like and suitable hoses, is provided according to a further characteristic feature of the invention. In this case, the supply with fresh cleaning liquid preferably occurs automatically. To refill the tub with cleaning liquid, the appropriate amount of cleaning liquid is conveyed from the refill container to the tub via said pump. When using nozzles for applying the cleaning liquid, the cleaning liquid is ideally blown from an air-tightly closed reservoir to the welding torch via nozzles by the aid of compressed air. In doing so, an adjustable amount of cleaning liquid may be fed to the nozzles from a small intermediate container through a flexible conduit by powering with compressed air. As soon as the compressed air has been switched off, an underpressure is temporarily formed in said intermediate container, which causes liquid to be automatically drawn from the larger reservoir into the smaller intermediate container. At the next powering with compressed air, this small intermediate container will be emptied again.

The device for applying cleaning liquid may likewise be connected with a liquid connection.

In order to enable cleaning of the welding torch in a manner as automatizable as possible, a device for detecting the immersion depth of the welding torch in the coil as described above may be arranged on the opening of the coil, which may, for instance, be comprised of an optical sensor.

Furthermore, a separation device as already mentioned above may also be provided and preferably arranged below the coil.

Finally, a device for controlling the temperature of the cleaning liquid may be provided in order to reach the optimum temperature of the cleaning liquid.

Suitable sensors may again be provided for detecting the presence of a welding torch in the cleaning apparatus.

Furthermore, suitable sensors for detecting the filling level in the tub and/or refill container may be provided in order to realize as automated a cleaning procedure as possible.

Finally, a control device, or an interface for connection to a control device, may be provided, which is preferably connected with the coil and the supply device for the coil and optionally further components of the cleaning apparatus.

In this case, all of the existing components of the cleaning apparatus may be interconnected via a bus system.

The present invention will be explained in more detail by way of the accompanying drawings, which illustrate exemplary embodiments of the invention.

Therein:

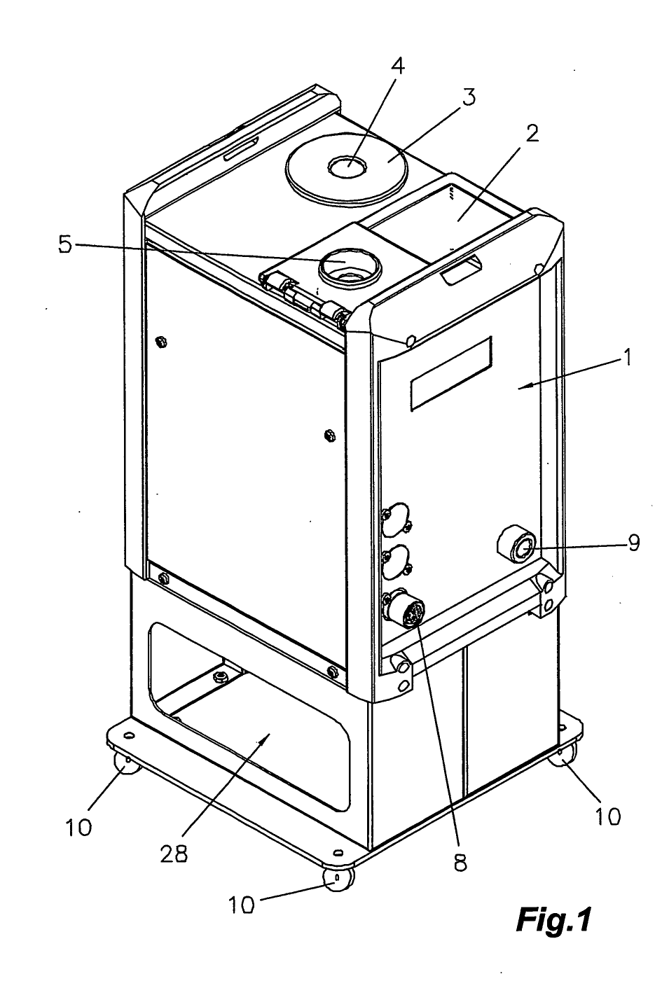

FIG. 1 is a perspective view of a cleaning apparatus according to the invention;

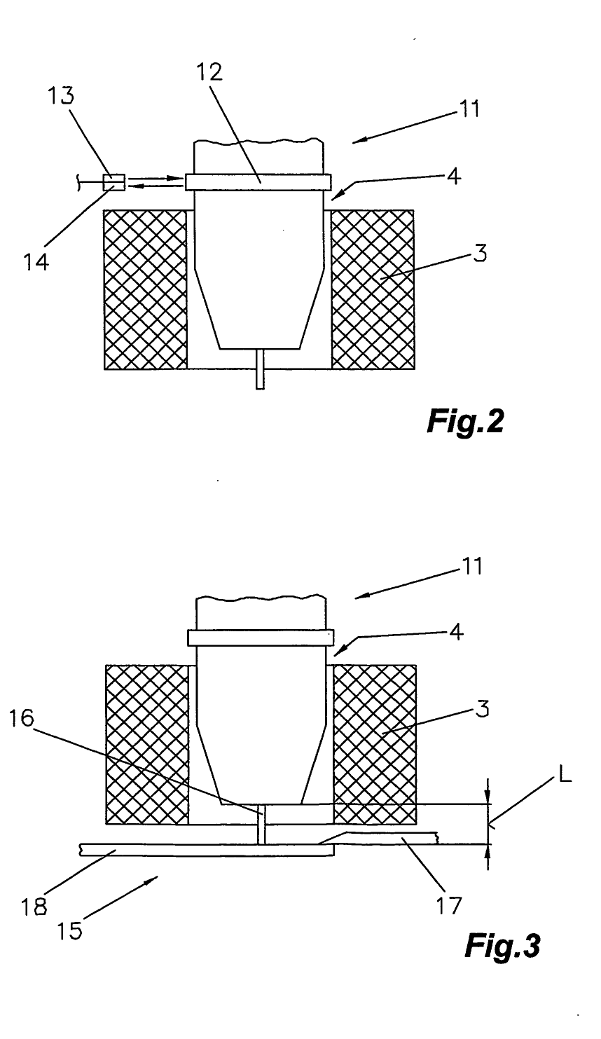

FIG. 2 is a sectional representation through a coil with a welding torch arranged therein, including a device for detecting the immersion depth of the welding torch;

FIG. 3 is a sectional representation through a coil with a welding torch arranged therein, including a device for cutting the welding wire at a defined length;

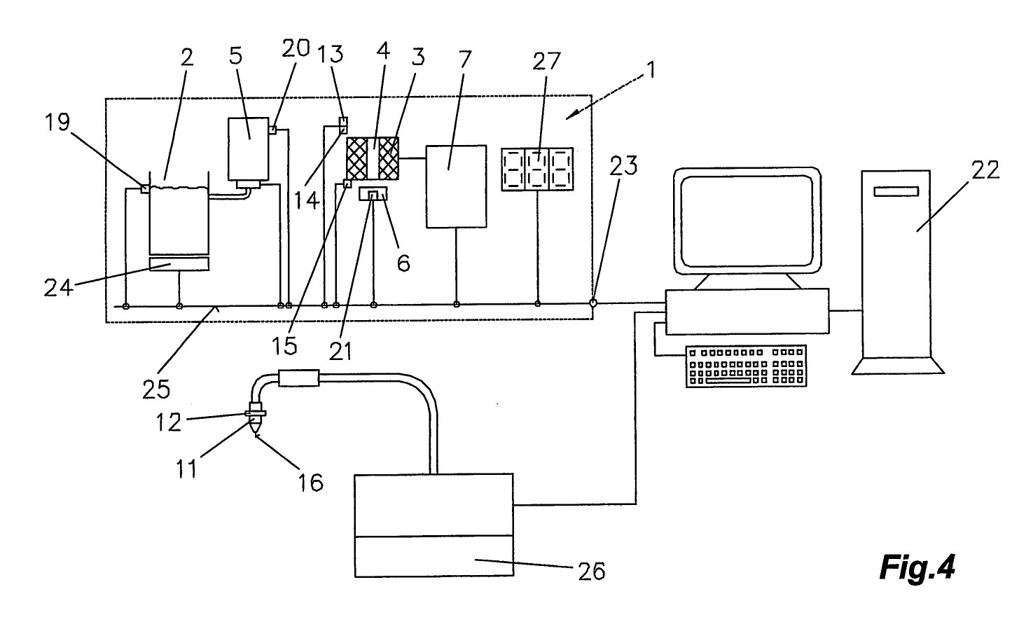

FIG. 4 is a block diagram of the components arranged within the cleaning apparatus;

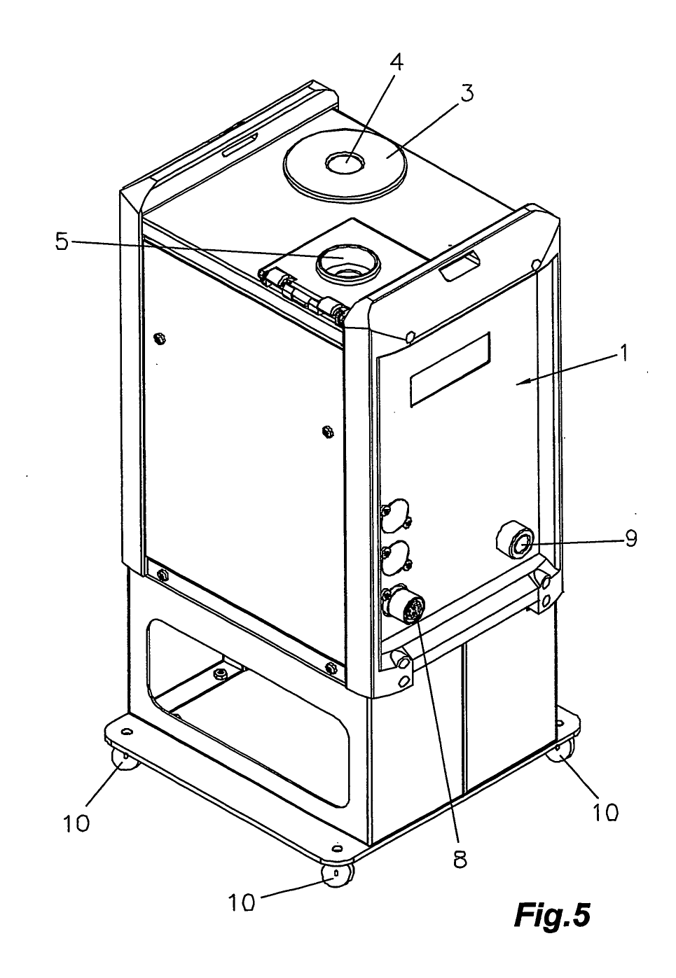

FIG. 5 is a perspective view of another embodiment of the cleaning apparatus according to the invention;

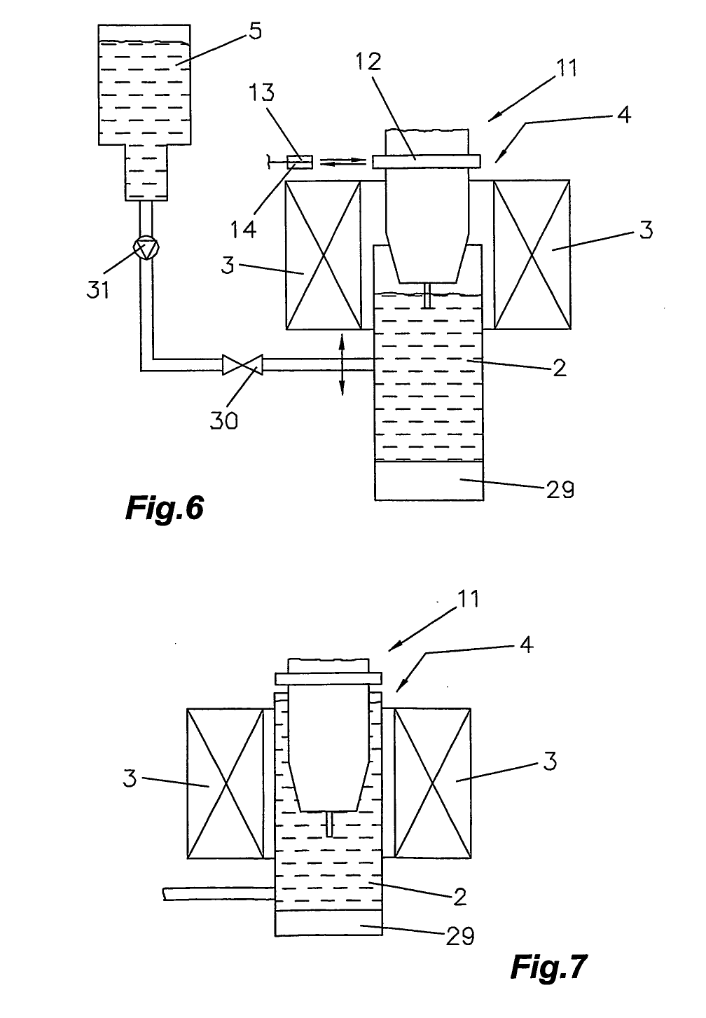

FIG. 6 is a sectional representation through a coil with a welding torch arranged therein and a cleaning liquid tub arranged therebelow;

FIG. 7 is an embodiment modified as compared to FIG. 6;

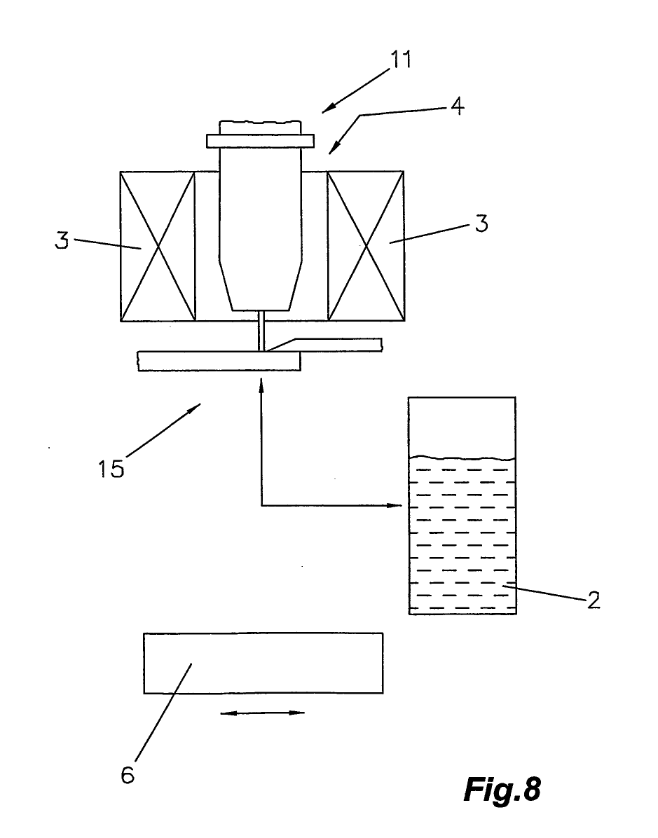

FIG. 8 is a sectional representation through a coil with a welding torch arranged therein, and a cutting device arranged therebelow, and a movably arranged tub containing cleaning liquid, and a waste receptacle;

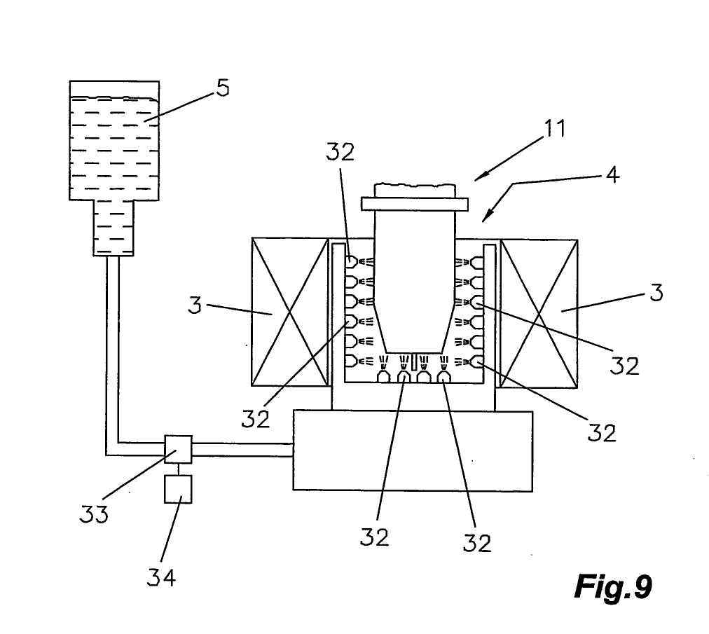

FIG. 9 is a cleaning apparatus including nozzles for spraying the cleaning liquid; and

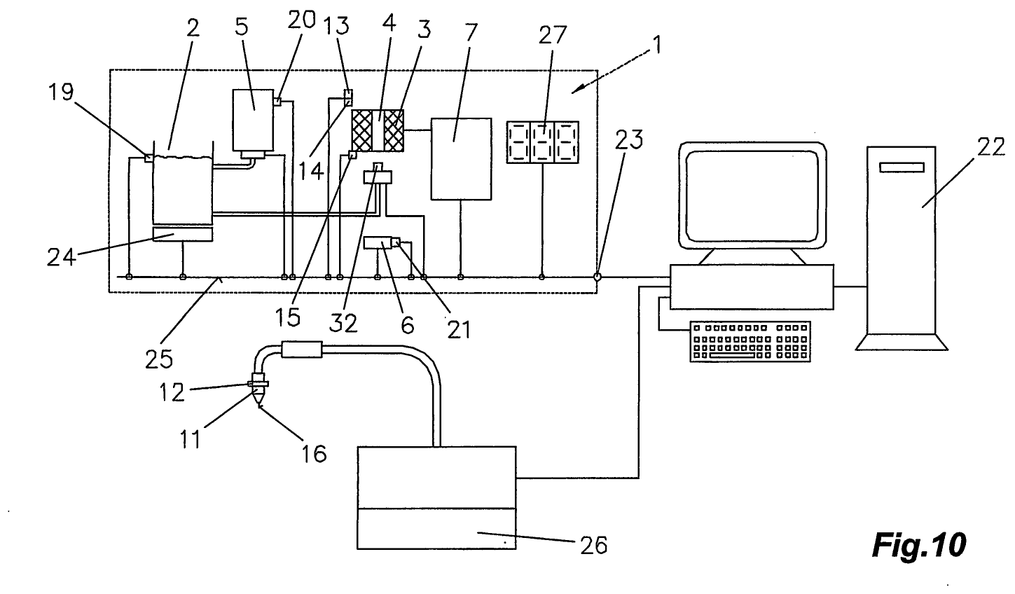

FIG. 10 is a further block diagram of the components arranged in the cleaning apparatus.

FIG. 1 is a perspective view of a cleaning apparatus comprising a housing 1 arranged in a cupboard-like manner and containing all the components provided for the cleaning of a welding torch. Thus, a tub 2 is provided in the housing 1 for the liquid, for instance cleaning liquid, into which the welding torch is immersed to cool the metal spatters adhering to it. Beside the liquid tub 2, a refill container 5 may be arranged to supply the tub 2 with liquid. Arranged behind the tub 2 is a coil 3 including an opening 4. After immersion in the tub 2, the welding torch is inserted into the opening 4 of the coil 3. After the supply of the coil 3 with electric power, the metal spatters on the welding torch are removed in a contactless manner. The foreign substances drop into a waste receptacle 6 (not illustrated) provided below the coil 3. Said waste receptacle 6 may be readily removed and emptied upon opening of a part of the housing 1. The supply device 7 (not illustrated) for the coil 3 likewise is preferably arranged within the housing 1. It is, moreover, feasible to arrange the supply device 7 externally and connect it with the coil 3 via an appropriate connection socket 8. Similarly, it is also feasible to arrange an appropriate liquid connection 9 on the housing 1, via which the tub 2 may, for instance, be emptied or may be fed with cleaning liquid. In order to enable the housing 1 to be readily taken to the place of use, it is possible to provide wheels 10 or the like. Such wheels 10 or the like may be equipped with suitable fixing means (not illustrated) in order to enable the cleaning apparatus to be sufficiently fixed, and stabilized in its position, on the respective place of use. A free space 28 may be provided below or within the housing 1 to serve as a storage for refill containers 5 or other consumption material or the like occurring during the cleaning procedure. In addition, it is feasible to arrange an accordingly large refill container 5 in said free space 28 and connect the same with the tub 2 via a conduit and pump. This will help to attain particularly long service lives of the cleaning apparatus, what is of particular relevance to the motorcar industry with its robot welding plants. Refilling of the tub 2 with liquid is preferably effected in a fully automated manner.

FIG. 2 is a schematic sectional view through the coil 3 with an inserted welding torch 11, wherein a reflex ring 12 is arranged on the welding torch 11 for detection of the immersion depth of the welding torch 11 within the opening 4 of the coil 3. To this end, the device for detecting the immersion depth comprises a light source 13 and an optical sensor 14 detecting the light rays reflected by the reflex ring 12. After having detected the light through the optical sensor 14, the advance movement by which the welding torch 11 is introduced into the opening 4 of the coil 3 can be stopped. The device for detecting of the immersion depth of the welding torch 11 may, of course, also be formed by other and, for instance, mechanical elements.

FIG. 3 is a schematic view through a coil 3 with a welding torch 11 inserted therein, a device 15 for cutting a welding wire 16 supplied to the welding torch 11 being arranged below the coil 3. A knife 17 which serves to cut the welding wire 16 is arranged below the coil 3. A stop plate 18 preferably made of an electrically conductive material serves to adjust the optimum length L by which the welding wire 16 projects out of the welding torch 11. That length L is the so-called stick-out length, which is important for the optimum operation of the welding torch 11. In order to adjust the optimum length L, the welding wire 16 is displaced until it contacts the stop plate 18. The contact of the welding wire 16 with the stop plate 18 may be determined in a particularly simple manner by measuring the electric resistance between the welding wire 16 and the stop plate 18 or by applying an electric current.

FIG. 4 is a schematic block diagram showing the components of the cleaning apparatus. The tub 2, the coil 3 and the supply device 7 as well as an optional refill container 5 are advantageously arranged within a common housing 1. On the tub 2, a sensor 19 may be provided for detecting the filling level in the tub 2. Similarly, a sensor 20 may be arranged to detect the filling level in the refill container 5. Above the coil 3, a device for detecting the immersion depth of the welding torch 11 may be provided, which may, for instance, be comprised of an above-described optical sensor 14 and a light source 13 together with a reflex ring 12 arranged on the welding torch 11. The waste receptacle 6, which may be equipped with a sensor 21 for detecting the amount of foreign matter, is arranged below the coil 3. Also below the coil 3 may be located the cutting device 15 for the welding wire 16. Below the tub 2, a device 24 for controlling the temperature of the liquid contained in the tub 2 may be arranged. In order to ensure the automatic control of the cleaning procedure, the coil 3, the supply device 7 for the coil 3, the optional device for detecting the immersion depth of the welding torch 11 within the coil 3, the optional cutting device 15 and the optional temperature control device 24 as well as optional sensors 19, 20, 21 are preferably interconnected by a bus system 25 and connected to a suitable control device 22 formed, for instance, by a computer. Instead of a control device 22 integrated in the housing 1, the bus system 25 may also be connected with an external control device 22 via a suitable interface 23. The welding torch 11, or the overall welding plant, or the welding robot 26, respectively, is also connected with said control device 22. A display 27, which may also be connected with the bus system 25, may be arranged on the housing 1 to indicate defined operating states.

FIG. 5 is a perspective view of another embodiment of the cleaning apparatus, wherein, as opposed to the variant according to FIG. 1, the device for applying cleaning liquid is arranged below the coil 3 within the housing 1 (not visible). By arranging the device for applying cleaning liquid or wetting liquid below the opening 4 of the coil 3, the cleaning procedure may be performed at a substantially constant position of the welding torch.

FIG. 6 is a schematic sectional view through a coil 3 containing a welding torch 11 arranged in the opening 4 of the coil 3. A device for detecting the immersion depth of the welding torch 11 in the opening 4 of the coil 3 may be provided as in accordance with FIG. 2. According to the invention, the device for applying cleaning liquid, which is realized by a tub 2, is arranged below the coil 3. The tub 2 may be connected with a device 29 for, preferably vertical, movement. In this manner, the immersion of the tip of the welding torch 11 into the cleaning liquid may be effected by lifting the tub 2, whereupon the tub 2 is again lowered and optionally pivoted. The tub 2 may be connected with a refill container 5. Refilling of the tub 2 may be realized in that the refill container 5 is arranged on a higher level than the tub 2 such that cleaning liquid will flow from the refill container 5 into the tub 2 only upon opening of a valve 30. Alternatively, or additionally to the valve 30, a pump 31 may, of course, be provided to transport cleaning liquid from the refill container 5 into the tub 2. By lowering the tub 2 after electromagnetic cleaning of the welding torch 11, the separated metal spatters are removed in the tub 2 by the surface tension of the cleaning liquid, whereupon they will descend in the tub 2.

FIG. 7 depicts a variant of a cleaning apparatus, in which the device for applying cleaning liquid, which is realized by a tub 2, is arranged within the opening 4 of the coil 3 to be optionally movable in the vertical direction by the device 29. Electromagnetic cleaning of the welding torch 11 may take place at a time at which the welding torch 11 is immersed in the cleaning liquid contained in the tub 2. The removed metal spatters will then descend onto the bottom of the tub 2.

FIG. 8 depicts another variant of a cleaning apparatus, in which a waste receptacle 6 is arranged below the opening 4 of the coil 3 in a preferably pivotable or displaceable manner. It is thereby feasible to apply cleaning liquid by moving the tub 2 to the tip of the welding torch 11 without changing the position of the welding torch 11. After the immersion of the tip of the welding torch 11, the tub 2 will be moved away so as to allow the electromagnetically removed foreign substances to collect in the waste receptacle 6. In addition, a device 15 for cutting a welding wire 16 fed to the welding torch 11 may be provided. The cutting device 15 too may be movably arranged so as to be locatable below the coil 3 only on demand.

FIG. 9 illustrates a variant of the invention, in which the device for applying cleaning liquid is comprised of several nozzles 32. The nozzles 32 may be arranged within the opening 4 of the coil 3, and/or below the opening 4 of the coil 3, and are oriented towards the welding torch 11 in a manner so as to spray cleaning liquid onto the welding torch sites with the most foreign substances. The nozzles 32 arranged below the opening 4 of the coil 3 are oriented towards the welding torch 11 in a manner so as to be able to apply cleaning liquid even in the interior of the gas nozzle of the welding torch 11, where weld spatters would also frequently choke the opening of the gas nozzle. The nozzles 32 are, for instance, connected with the refill container 5 for cleaning liquid via an intermediate container 33, whereby an adjustable amount of cleaning liquid is fed to the nozzles 32 by the aid of compressed air derived from a compressed-air source 34. As soon as the compressed air is switched off again, an underpressure is temporarily formed in said intermediate container 33, which causes cleaning liquid to be automatically drawn from the refill container 5 into the intermediate container 33. At the next compressed-air pulse from the compressed-air source 34, cleaning liquid can again be fed to the nozzles 32.

FIG. 10 is a schematic block diagram of the components of the cleaning apparatus in a modified form as compared to FIG. 4. There, the tub 2, the coil 3 and the supply device 7 as well as an optional refill container 5 may advantageously be arranged within a common housing 1. Besides the components already described in FIG. 4, also the nozzles 32 and/or the device 29 for vertically moving the tub 2 may preferably be connected with the control device 22 via the bus system 25. In addition, other components such as, e.g., a valve 30, a pump 31, a sensor for detecting the filling level in an intermediate container 33 as well as the compressed-air source 34 may be connected with the control device 22, preferably via the bus system 25 (not illustrated).

What is claimed is:

1. An apparatus for cleaning welding torches (11), including a device for applying cleaning liquid to the tip of a welding torch (11), and a coil (3) having an opening (4) for the insertion of the welding torch (11) to subject said welding torch to electromagnetic cleaning, and a supply device (7) connected with said coil (3), wherein the device for applying cleaning liquid and the coil (3) are arranged in a common housing (1) together with a waste receptacle (6) arranged below the coil (3) to receive the electromagnetically removed foreign substances.

2. A cleaning apparatus according to claim 1, wherein the device for applying cleaning liquid is comprised of a tub (2) containing cleaning liquid for the immersion of the welding torch (11).

3. A cleaning apparatus according to claim 1, wherein the device for applying cleaning liquid is comprised of at least one nozzle (32).

4. A cleaning apparatus according to claim 1, wherein the supply device (7) for the coil (3) is arranged in the housing (1).

5. A cleaning apparatus according to claim 1, wherein the waste receptacle (6) is pivotally arranged.

6. A cleaning apparatus according to claim 1, wherein the waste receptacle (6) is removable from the housing (1).

7. A cleaning apparatus according to claim 1, wherein a refill container (5) connected with the device for applying cleaning liquid is arranged in the housing (1).

8. A cleaning apparatus according to claim 1, wherein a liquid connection (9) connected with the device for applying cleaning liquid is arranged in the housing (1).

9. A cleaning apparatus according to claim 1, wherein the housing (1) comprises wheels (10) or the like.

10. A cleaning apparatus according to claim 1, wherein a device for detecting the immersion depth of the welding torch (11) in the coil (3) is arranged on the opening (4) of the coil (3).

11. A cleaning apparatus according to claim 10, wherein the device for detecting the immersion depth is comprised of a light source (13) and an optical sensor (14) detecting the light rays reflected by a reflex element, preferably a reflex ring (12), appropriately arranged on the welding torch (11).

12. A cleaning apparatus according to claim 1, wherein a device (15) for cutting a welding wire (16) fed to the welding torch (11) is arranged in the housing (1).

13. A cleaning apparatus according to claim 12, wherein the cutting device (15) is arranged below the coil (3).

14. A cleaning apparatus according to claim 13, wherein a stop plate (18) is arranged below the coil (3), against which the welding wire (16) is advanced in order to adjust the length (L) by which the welding wire (16) projects out of the welding torch (11).

15. A cleaning apparatus according to claim 14, wherein the stop plate (18) is made of an electrically conductive material such that the impact of the welding wire is detectable by the resulting electrical contact.

16. A cleaning apparatus according to claim 1, wherein a device for controlling the temperature of the cleaning liquid is provided.

17. A cleaning apparatus according to claim 1, wherein sensors (19, 20) are provided for detecting the welding torch (11).

18. A cleaning apparatus according to claim 1, wherein sensors (19, 20) are provided for detecting the filling level in the tub (2) and/or in the refill container (5).

19. A cleaning apparatus according to claim 1, wherein a control device (22) for controlling the cleaning procedure is arranged in the housing (1).

20. A cleaning apparatus according to claim 1, wherein an interface (23) for connection to a control device (22) for controlling the cleaning procedure is arranged on the housing (1).

21. A cleaning apparatus according to claim 19, wherein said control device (22) or interface (23) for the control device (22), respectively, is connected with the coil (3) and the supply device (7) for the coil (3) and the optional device for detecting the immersion depth of the welding torch (11) and the optional cutting device (15) and the optional temperature control device (24) and optional sensors (19, 20, 21).

22. A cleaning apparatus according to claim 1, wherein the components provided in the housing (1) are interconnected by a bus system (25).

23. A cleaning apparatus according to claim 1, wherein at least one display (27) is arranged on the housing (1).

24. A cleaning apparatus according to claim 1, wherein a free space (28) is provided below or within the housing (1), particularly for storing refill containers (5).

25. A cleaning apparatus according to claim 24, wherein at least one refill container (5) arranged in the free space (28) is connected via a pump or the like with the device for applying cleaning liquid.

26. An apparatus for cleaning welding torches (11), including a device for applying cleaning liquid to the tip of a welding torch (11), and a coil (3) having an opening (4) for the insertion of the welding torch (11) to subject said welding torch to electromagnetic cleaning, and a supply device (7) connected with said coil (3), wherein the device for applying cleaning liquid is arranged within or below the opening (4) of the coil (3) so as to enable the application of cleaning liquid and said electromagnetic cleaning substantially in the same position of the welding torch (11).

27. A cleaning apparatus according to claim 26, wherein the device for applying cleaning liquid is comprised of a tub (2) containing cleaning liquid.

28. A cleaning apparatus according to claim 27, wherein the tub (2) is connected with a device (29) for, preferably vertical, movement.

29. A cleaning apparatus according to claim 26, wherein the device for applying cleaning liquid is comprised of at least one nozzle (32).

30. A cleaning apparatus according to claim 29, wherein several nozzles (32) are arranged within the opening (4) of the coil (3).

31. A cleaning apparatus according to claim 29, wherein the at least one nozzle (32) is arranged below the opening (4) of the coil (3).

32. A cleaning apparatus according to claim 29, wherein at least one nozzle (32) is movably arranged.

33. A cleaning apparatus according to claim 26, wherein the device for applying cleaning liquid is connected with a refill container (5), preferably via a pump (31) or the like.

34. A cleaning apparatus according to claim 26, wherein the device for applying cleaning liquid is connected with a liquid connection (9).

35. A cleaning apparatus according to claim 26, wherein a device for detecting the immersion depth of the welding torch (11) in the coil (3) is arranged on the opening (4) of the coil (3).

36. A cleaning apparatus according to claim 35, wherein the device for detecting the immersion depth is comprised of a light source (13) and an optical sensor (14) detecting the light rays reflected by a reflex element, preferably a reflex ring (12), appropriately arranged on the welding torch (11).

37. A cleaning apparatus according to claim 26, wherein a device (15) for cutting a welding wire (16) fed to the welding torch (11) is arranged in the housing (1).

38. A cleaning apparatus according to claim 37, wherein the cutting device (15) is arranged below the coil (3).

39. A cleaning apparatus according to claim 38, wherein a stop plate (18) is arranged below the coil (3), against which the welding wire (16) is advanced in order to adjust the length (L) by which the welding wire (16) projects out of the welding torch (11).

40. A cleaning apparatus according to claim 39, wherein the stop plate (18) is made of an electrically conductive material such that the impact of the welding wire is detectable by the resulting electrical contact.

41. A cleaning apparatus according to claim 26, wherein a device for controlling the temperature of the cleaning liquid is provided.

42. A cleaning apparatus according to claim 26, wherein sensors are provided for detecting the welding torch (11).

43. A cleaning apparatus according to claim 26, wherein sensors (19, 20) are provided for detecting the filling level in the tub (2) and/or in the refill container (5).

44. A cleaning apparatus according to claim 26, wherein a control device (22) for controlling the cleaning procedure is provided.

45. A cleaning apparatus according to claim 26, wherein an interface (23) for connection to a control device (22) for controlling the cleaning procedure is provided.

46. A cleaning apparatus according to claim 44, wherein said control device (22) or interface (23) for the control device (22), respectively, is connected with the coil (3) and the supply device (7) for the coil (3) and optionally provided further devices of the cleaning apparatus.

47. A cleaning apparatus according to claim 26, wherein the components of the cleaning apparatus are interconnected by a bus system (25).
